(19) United States
(12) Patent Application Publication
(10) Pub. No.: US 2014/0082729 A1
(43) Pub. Date: Mar. 20, 2014

(54) SYSTEM AND METHOD FOR ANALYZING REPACKAGED APPLICATION THROUGH RISK CALCULATION

(71) Applicant: ESTsecurity Co., Ltd., Seoul (KR)

(72) Inventors: Ki Beom Shim, Seoul (KR); Myung Kuc Hwang, Seoul (KR); Jong Chul Kim, Seoul (KR); Jun Seob Kim, Seoul (KR)

(73) Assignee: ESTsecurity Co., Ltd., Seoul (KR)

(21) Appl. No.: 14/020,008

(22) Filed: Sep. 6, 2013

(30) Foreign Application Priority Data
Sep. 19, 2012 (KR) 2012-0103660

(51) Int. Cl. G06F 21/56

(52) U.S. Cl. CPC G06F 21/562
USPC 726/23

(57) ABSTRACT

The present invention relates to a system and method for analyzing a repackaged application through risk calculation, and more specifically, to a system and method for analyzing a repackaged application through risk calculation, which confirms existence of a malicious code by scoring whether or not an application installed in an Android smart phone is repackaged.

According to the present invention, malicious applications classified as a repackaged mutant may be extensively detected.

### CROSS-REFERENCE TO RELATED APPLICATIONS

This application claims the priority of Korean Application No. 2012-0103660, filed on Sep. 19, 2012. The contents of the application are hereby incorporated by reference in its entirety.

### FIELD OF THE INVENTION

The present invention relates to a system and method for analyzing a repackaged application through risk calculation, and more specifically, to a system and method for analyzing a repackaged application through risk calculation, which confirms existence of a malicious code by scoring whether or not an application installed in an Android smart phone is repackaged.

### BACKGROUND OF THE RELATED ART

Operating systems (OS) which control operations of a smart phone include iOS of Apple, Android of Google, Symbian of Nokia, Blackberry of RIM, Windows Mobile of Microsoft and the like. Among these, iOS and Android are most widely used, and, unlike iOS, applications of which are distributed in a closed way only through an App store operated by Apple, smart phones using Android OS may download applications through a variety of channels.

Since Android applications propagated through various forms of application markets contain a malicious code created with malicious intent, information may be leaked against the intention of a user while the user uses the applications.

Although a lot of vaccine programs or malicious code detection programs for smart phones are released, it is practically impossible to detect all the tens of thousands of applications released in a day, and users downloading and using the applications should pay attention by personally inspecting inclusion of a malicious code.

Particularly, since applications registered in a black market, i.e., a private market which is not a normal Android market, does not go through even a minimum verification procedure, the black market is used as a channel for distributing malicious applications such as repackaged applications.

FIG. 1 is a block diagram showing the structure of a system for detecting a malicious code in an Android application according to a conventional technique.

As shown in FIG. 1, a portable terminal 1 installed with a malicious code detection system is configured to include an application unit 2 for executing a sample application 10, an application framework 3 for performing functions of cellular phone scanning 12, real-time detection 14, confirmation of scanning history 16, pattern update 18 and the like, and a library 4 configured of a check file 20 and an encrypted crypto 22, on the basis of Linux Kernel 5.

A pattern server 50 is configured to include a pattern data 54 for updating patterns for diagnosing malicious codes and dangerous files of the portable terminal 1 and a crypto server 52 for encrypting and providing the pattern data 54 to the portable terminal 1.

If scanning the SD card folder and applications of the portable terminal 1 is started, a list of the entire files of an SD card and a list of the applications installed in the portable terminal 1 are loaded.

The file extension of an execution file is apk in the Android operating system, and various files are compressed therein.

The application framework 3 progresses a signature-based pattern inspection on execution files having apk as a file extension. The signature-based pattern inspection is comparing a pattern with those of previously defined and stored malicious codes, and whether or not the patterns are matched is determined in order to inspect existence of a malicious code.

If a pattern matching to the pattern of an inspected execution file exists as a result of determination on the pattern, the execution file corresponding to the pattern is determined as a malicious code. If a pattern matching to the pattern of the inspected execution file does not exist as a result of the determination, whether or not the corresponding file is dangerous is secondarily determined through a heuristic inspection.

If all these inspections are completed, the results of the inspections are stored in a database.

In addition, in a method of diagnosing whether or not a file is dangerous through the heuristic inspection, a file having a file extension of apk is decompressed first, and then existence of an AndroidManifest.xml file is confirmed.

The AdroidManifest.xml file is a file which stores permissions for Internet connection, address book access, system access and the like, and permissions stored in a pattern database are confirmed by comparing a byte.

The pattern database is divided into a heuristic pattern and a virus pattern.

The heuristic pattern inspection regards a file as dangerous if the Internet access right is combined with other permissions, and it is since that if the Internet access right is combined with a right to read an address book, read a data, read a character message, confirm records of a cellular phone, confirm location information, confirm cellular phone information or the like, the file can be transmitted to other servers.

Since an application that may have such a problem described above may acquire and transmit information on the cellular phone to outside without the knowledge of a user, the application is preferably regarded as a malicious application and informed to the user.

However, it is worried that such a detection method may not detect whether or not an application has a malicious code when the detection method is applied to a ‘repackaged application’ reconstructed in a new way by a third party. That is, when a Dex file contained in an application is newly created and the application is repackaged using the new Dex file, the repackaged application is regarded as having a normal right that a normal application has, and it may not be determined as a malicious code.

### SUMMARY OF THE INVENTION

Therefore, the present invention has been made in view of the above problems, and it is an object of the present invention to provide a system and method for analyzing a repackaged application through risk calculation, which can detect an application repackaged by a third party without permission and attached with a malicious code by analyzing a name, an ID or a string in an AndroidManifest file and a Dex file included in an Android application.

Another object of the present invention is to provide a system and method for analyzing a repackaged application through risk calculation, which can classify an application into stages of a repackaged application, a repackaging suspected application and a normal application by scoring the risk of a repackaged application into sections of points.

To accomplish the above objects, according to one aspect of the present invention, there is provided a system for detecting a repackaged application by analyzing an Android application, the system including: a decompiler 102 for loading the Android application, which is an analysis target, decompressing the application and extracting an AndroidManifest file and a Dex file; an analysis module 106 for analyzing whether or not specific information is modified in the extracted AndroidManifest or Dex file; a blacklist database 108 for storing a blacklist collecting IDs of publishers related to creation and distribution of a malicious code, a white list collecting IDs of publishers unrelated to creation and distribution of the malicious code, and information on malicious package names and malicious code character strings; and a risk calculation module 110 for converting, if analysis information on the Android application created by the analysis module 106 is transmitted, a risk expressing possibility of the malicious code to be contained in the Android application as a score based on the analysis information; wherein the Android application, which is the analysis target, is classified as one of a normal application, a repackaging suspected application and a repackaged malicious application depending on the risk.

The analysis module 106 includes: a name analyzer 106a for extracting a package name and a main activity name from application information contained in the AndroidManifest file, analyzing a degree of similarity between the package name and the main activity name, and transferring the degree of similarity to the risk calculation module 110; an ID analyzer 106b for analyzing whether or not a publisher ID contained in the AndroidManifest file is found in the white list or the blacklist, and transferring a result of the analysis to the risk calculation module 110; and a string analyzer 106c for analyzing whether or not a malicious package name or a malicious code character string is found in the AndroidManifest file or the Dex file, and transferring a result of the analysis to the risk calculation module 110.

According to another aspect of the present invention, there is provided a method of detecting a repackaged application using the analysis system described above, the method including: a first step of loading an Android application, which is an analysis target, decompressing the application and extracting an AndroidManifest file and a Dex file, by a decompiler 102; a second step of analyzing whether or not specific information is modified in the extracted AndroidManifest or Dex file, by an analysis module 106; a third step of converting, if analysis information on the Android application created by the analysis module 106 is transmitted, a risk expressing possibility of the malicious code to be contained in the Android application as a score based on the analysis information, by a risk calculation module 110; and a fourth step of classifying the Android application as one of a normal application, a repackaging suspected application and a repackaged malicious application depending on the risk, by the risk calculation module 110.

The second step includes: a 2-1 step of extracting a package name and a main activity name from application information contained in the AndroidManifest file, analyzing a degree of similarity between the package name and the main activity name, and transferring the degree of similarity to the risk calculation module 110, by a name analyzer 106a included in the analysis module 106; a 2-2 step of analyzing whether a publisher ID contained in the AndroidManifest file is found in a white list or a blacklist, and transferring a result of the analysis to the risk calculation module 110, by an ID analyzer 106b included in the analysis module 106; and a 2-3 step of analyzing whether or not a malicious package name or a malicious code character string is found in the AndroidManifest file or the Dex file, and transferring a result of the analysis to the risk calculation module 110, by a string analyzer 106c included in the analysis module 106.

As a result of the analysis of the name analyzer 106a at the 2-1 step, if the main activity name is configured in a form of combining the ‘package name’ and a ‘last portion of the package name’ using ‘.’, the risk calculation module 110 adds 5% points to the risk score of the Android application, if the main activity name is different from the package name and does not contain the package name, the risk calculation module 110 adds 50% points to the risk score of the Android application, and if the main activity name is different from the package name and contains the package name, the risk calculation module 110 adds 15% points to the risk score of the Android application, and

As a result of the analysis of the ID analyzer 106b at the 2-2 step, if the publisher ID is contained in the white list, the risk calculation module 110 adds no point to the risk score of the Android application, if the publisher ID is contained in the blacklist, the risk calculation module 110 adds 20% points to the risk score of the Android application, and if the publisher ID is not contained in both the white list and the blacklist, the risk calculation module 110 adds 10% points to the risk score of the Android application.

As a result of the analysis of the string analyzer 106c at the 2-3 step, if the malicious package name and the malicious code character string are not found, the risk calculation module 110 adds no point to the risk score of the Android application, if the malicious package name is found, the risk calculation module 110 adds 12% points to the risk score of the Android application, and if the malicious code character string is found, the risk calculation module 110 adds 30% points to the risk score of the Android application.

### BRIEF DESCRIPTION OF THE DRAWINGS

FIG. 1 is a block diagram showing the structure of a system for detecting a malicious code in an Android application according to a conventional technique.

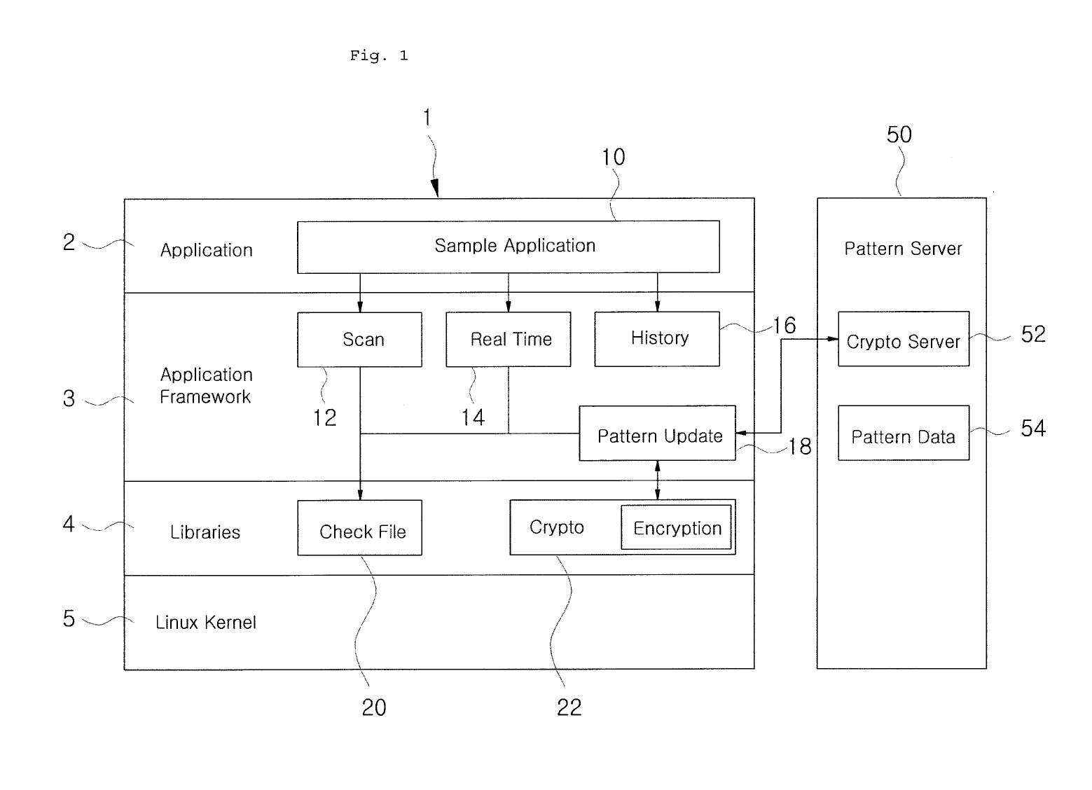

FIG. 2 is a block diagram showing the structure of a malicious code detection system according to an embodiment of the present invention.

FIG. 3 is a flowchart illustrating a method of analyzing a malicious code using the analysis system of FIG. 2.

FIG. 4 is a table showing the structure of a package name and a main activity name in a normal application.

FIG. 5 is a table showing the structure of a package name and a main activity name in a repackaged malicious application.

FIG. 6 is a table showing the structure of a package name and a main activity name in a repackaging suspected application.

FIG. 7 is a table showing a portion displaying a publisher ID in an application.

FIG. 8 is a table showing a representative example of malicious package names and malicious code character strings.

FIG. 9 is a table showing the types of applications corresponding to risk points.

DESCRIPTION OF SYMBOLS

| | |
|---|---|
| 100: Analysis system | 102: Decompiler |
| 104: Application database | 106: Analysis module |
| 108: Blacklist database | 110: Risk calculation module |

### DETAILED DESCRIPTION OF THE PREFERRED EMBODIMENT

A “system and method for analyzing a repackaged application through risk calculation” according to an embodiment of the present invention will be hereafter described with reference to the accompanying drawings.

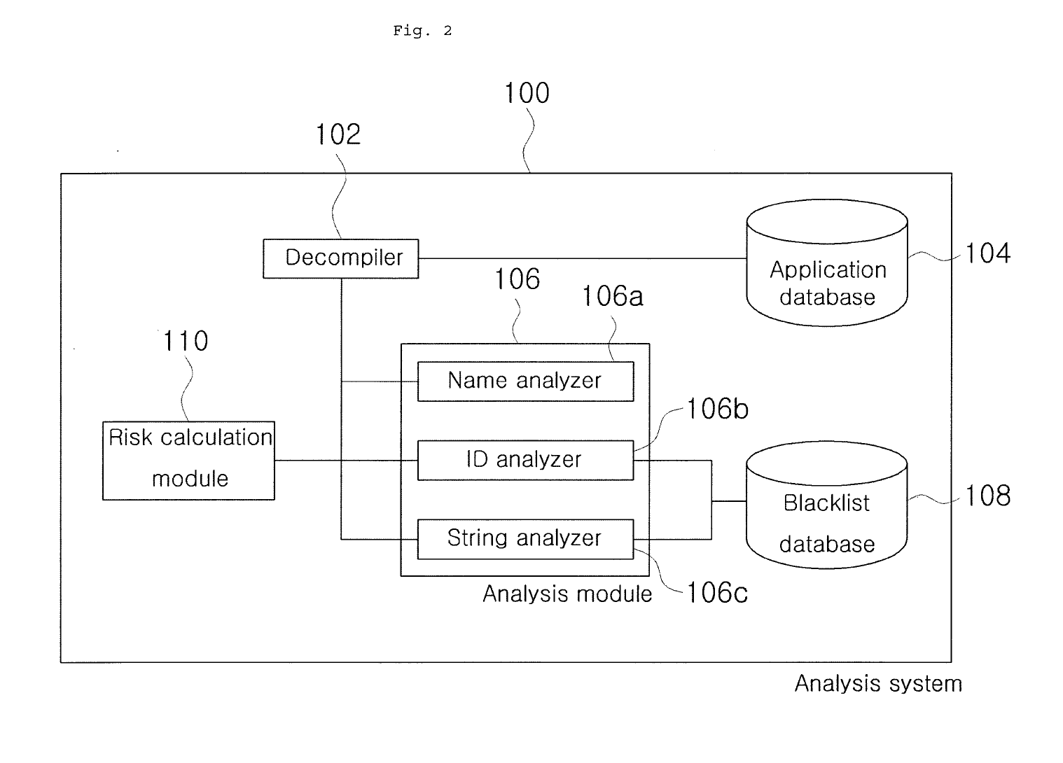

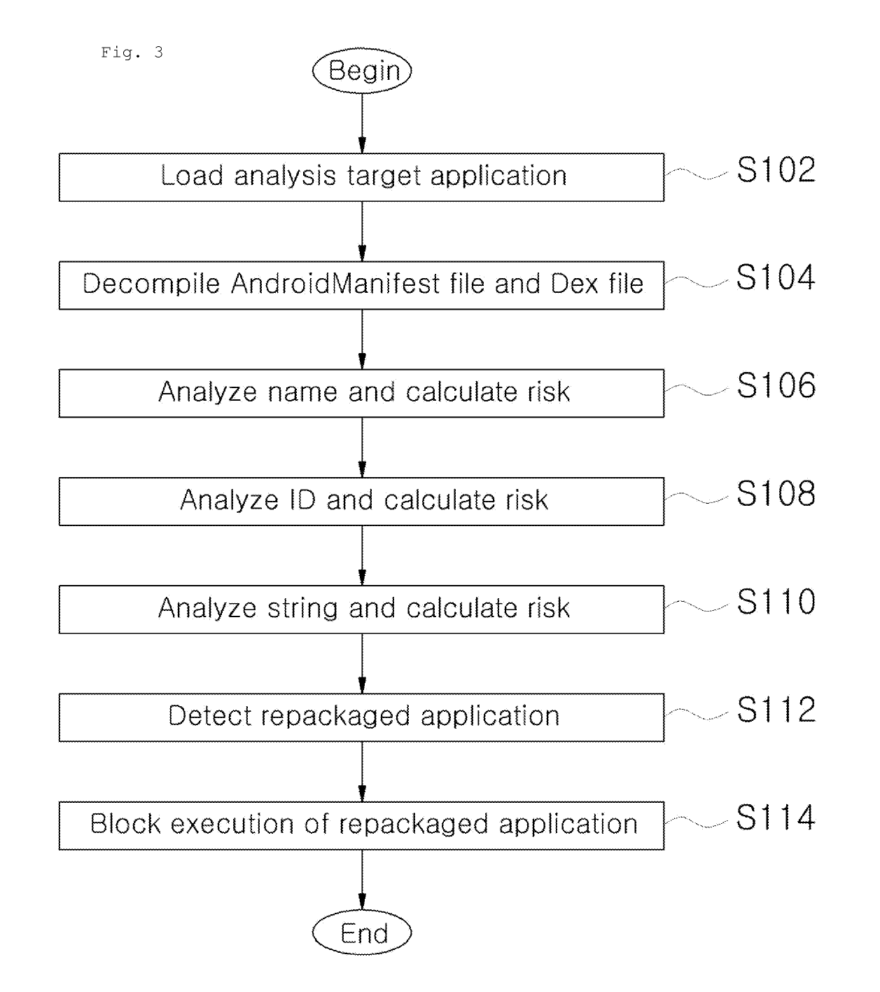

FIG. 2 is a block diagram showing the structure of a malicious code detection system according to an embodiment of the present invention, and FIG. 3 is a flowchart illustrating a method of analyzing a malicious code using the analysis system of FIG. 2.

The analysis system and method will be described together referring to FIGS. 2 and 3.

The analysis system 100 of the present invention includes a decomplier 102, an application database 104, an analysis module 106, a blacklist database 108 and a risk calculation module 110.

The decompiler 102 loads an Android application file (an execution file having a file extension of apk) stored in the application database 104, decompresses (decompiles) the application file and extracts an AndroidManifest file and a Dex file. The extracted AndroidManifest file and Dex file are transferred to the analysis module 106, and detection of a repackaged application is performed.

The AndroidManifest file is a file containing information on the type of activity of an application and the type of right needed for the activity, including application information such as a version, a name, an execution right and the like of a project.

The Dex file is an execution file created using compiled Java classes, which is a file created by converting a Java class file into a byte code so that the Dalvik Virtual Machine of an Android terminal may recognize. The Dalvik Virtual Machine loads a specific Java class from the Dex file and executes an operation aimed at by an application.

The AndroidManifest file is decompiled as a text document by the decompiler 102, and the Dex file is decompiled as a jar file (*.jar) or a Java file (*.java).

The analysis module 106 grasps whether or not an application is repackaged with malicious intent by determining whether or not specific information is modified in the AndroidManifest file or the Dex file decompressed and transferred by the decompiler 102.

A name analyzer 106a analyzes how similar the package name is to the main activity name among the application information contained in the decompiled AndroidManifest file.

An activity is a basic unit of an application, and a plurality of activities configures an application. Among the activities, an activity executed first when the application starts to operate is defined as the main activity.

Since an error occurs in a program if the package name is identical to the main activity in an Android application, the package name is not identical to the main activity even in a normal Android application.

In addition, since there is no problem in the operation of an application even when the two names are different, the names may be freely determined by the selection of a developer. However, since most of Android applications use the last portion of the package name as the main activity name in many cases, it is determined whether or not an application is repackaged using such a feature.

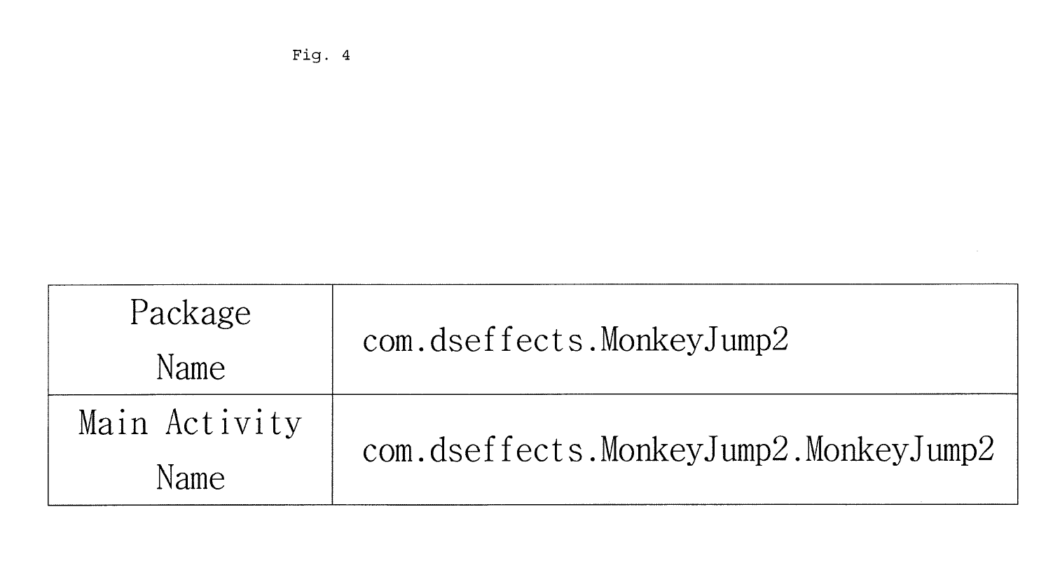

FIG. 4 is a table showing the structure of a package name and a main activity name in a normal application.

The package name and the main activity have a structure in which extensions or phrases are concatenated using “.”, and ‘the last portion of a package name’ means a character string following the last “.”.

In FIG. 4, the package name is “com.dseffects.MonkeyJump2”, and “MonkeyJump2” appearing at the rearmost section is the ‘the last portion of a package name’.

A normal main activity name is configured in the form of appending “.” and ‘the last portion of a package name’ to the package name, e.g., com.dseffects.MonkeyJump2.MonkeyJump2.

An application having a main activity name formed as such is regarded as a normal application.

In order to confirm the main activity name, an activity having a phrase formed as “android:name=“android.intent.action.MAIN”” is searched for by analyzing the decompiled AndroidManifest file.

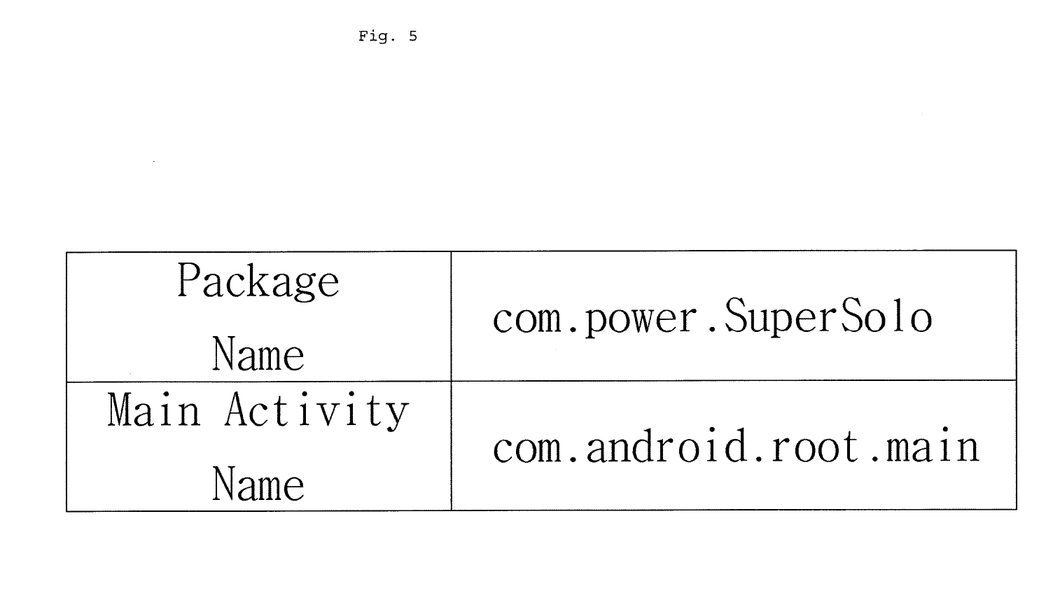

FIG. 5 is a table showing the structure of a package name and a main activity name in a repackaged malicious application.

As shown in FIG. 5, if the package name (com.power.SuperSolo) is completely different from the main activity name (com.android.root.main), the application is determined as a repackaged application.

In addition, there are some cases where a word not in the package name is added and used as a main activity name although the package name is not completely identical to the main activity name. In this case, although the application may not be regarded as a normal application, it also cannot be determined as a repackaged application. Accordingly, certain points are granted to an application, and a risk corresponding to the points is calculated when the application is finally analyzed, and such an application is defined as a ‘repackaging suspected application’.

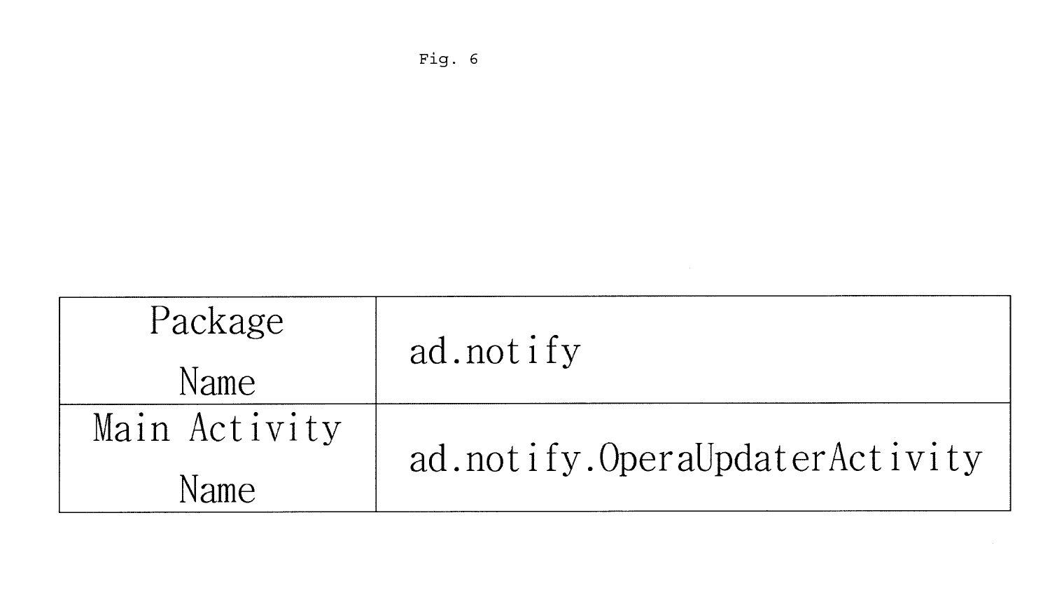

FIG. 6 is a table showing the structure of a package name and a main activity name in a repackaging suspected application.

As shown in FIG. 6, although the package name (ad.notify) is contained in the main activity name (ad.notify.OperaUpdaterActivity), when it is not that the ‘the last portion of a package name’ is appended to the package name, but a completely different character string (OperaUpdaterActivity) is appended, the application is classified as a repackaging suspected application.

Meanwhile, an ID analyzer 106b determines whether or not the publisher has been related to a malicious code by analyzing the publisher ID among the application information contained in the decompiled AndroidManifest file.

The publisher ID is an ID used for identifying a publisher when an advertisement is inserted in an application, and it is used to show the identity of a specific distributor.

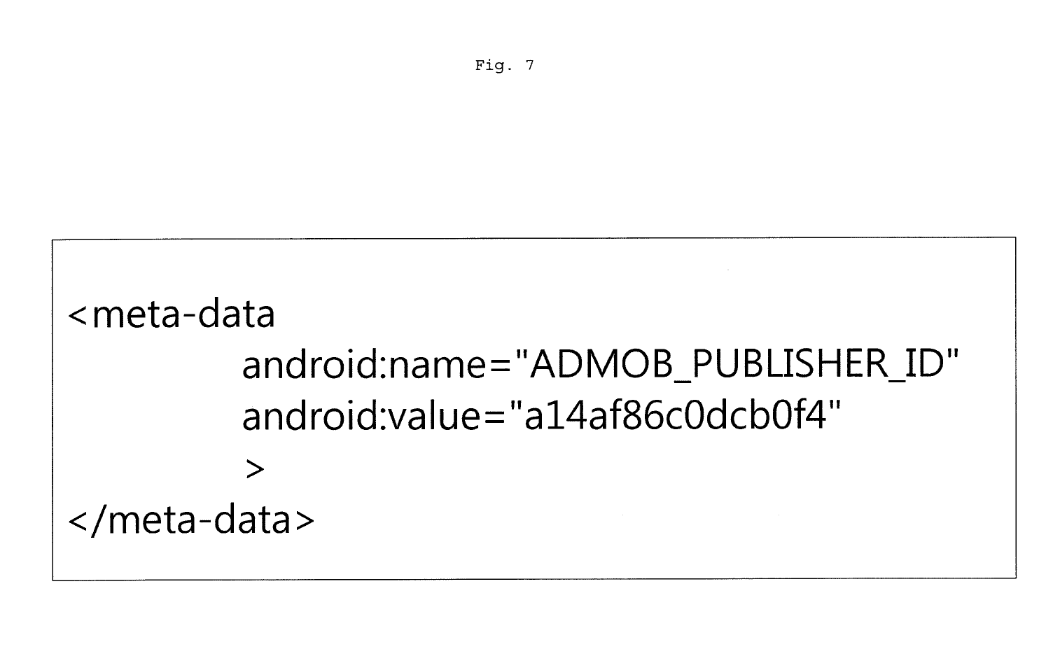

FIG. 7 is a table showing a portion displaying a publisher ID in an application. In the application, a value following the “android:value=” in a section displaying “PUBLISHER ID” is the publisher ID. In FIG. 7, “a14af86c0dcb0f4” is the publisher ID.

The analysis system 100 detects a repackaged application using a blacklist collecting IDs of publishers suspected as being related to creation or distribution of a malicious code in the past.

The blacklist recording the IDs of malicious publishers is stored in the blacklist database 108, and the blacklist database 108 is updated periodically or whenever an event occurs.

The blacklist database 108 stores a white list, in addition to the blacklist. The white list is a collection of IDs of normal publishers unrelated to a malicious code, and it may be quite natural to regard an application created and distributed by a specific publisher as a normal application if the ID of the specific publisher is contained in the white list. The ID analyzer 106b searches both the white list and the blacklist and confirms whether or not a publisher ID is found therein.

Meanwhile, the string analyzer 106c detects a repackaged application by analyzing whether or not a malicious package name or a malicious code character string (malware string) is contained in the decompiled AndroidManifest file or Dex file.

The malicious package name is a name that has been used in the past as a package name of an application containing a malicious code. In addition, the malicious code character string is a character string frequently used in a malicious application and includes information on a character string that has been found by analyzing a malicious application detected in the past.

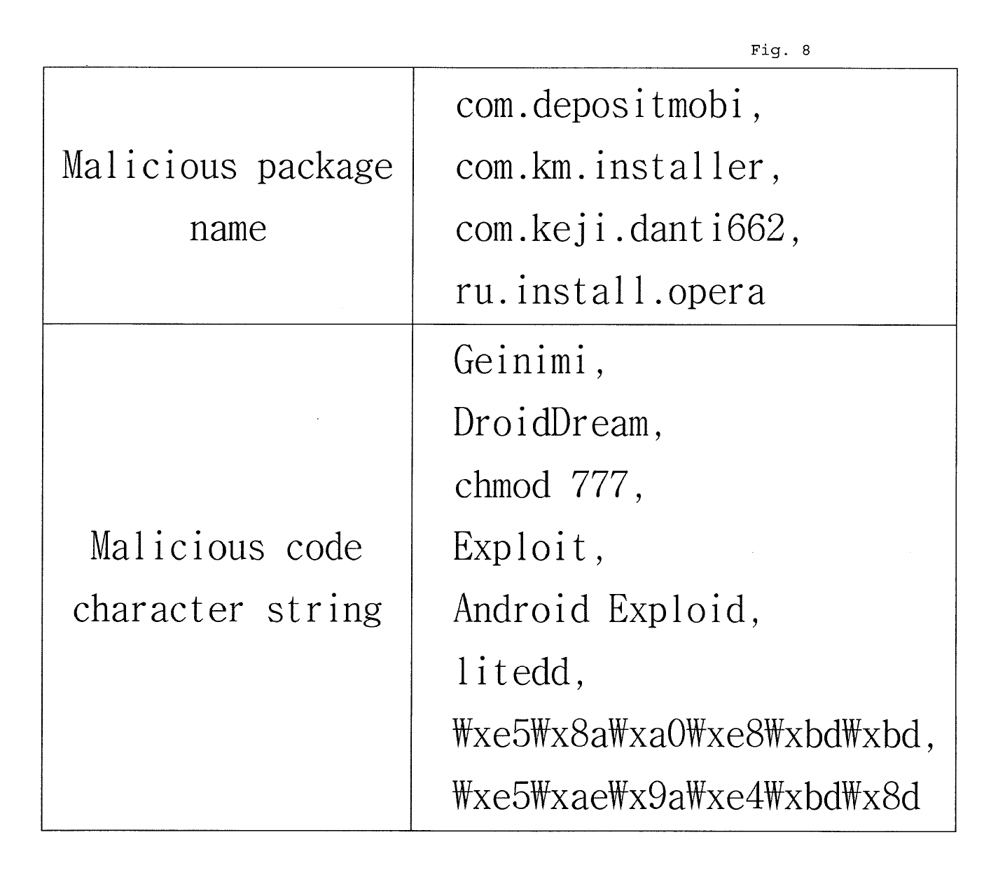

FIG. 8 is a table showing a representative example of malicious package names and malicious code character strings.

Names of representative malicious packages and information on malicious code character strings are stored in the blacklist database 108, and the blacklist is updated whenever a new malicious code is found.

The analysis information of an application analyzed by the name analyzer 106a, the ID analyzer 106b and the string analyzer 106c is transferred to the risk calculation module 110.

The application analysis information contains data regarding how similar the package name is to the main activity name in the application, whether or not a publisher ID is found in the white list or the blacklist of the blacklist database 108, and whether or not a malicious package name or a malicious code character string is found in the AndroidManifest file or the Dex file.

The risk calculation module 110 receiving the application analysis information converts the risk of a corresponding application into a score according to the degree of the analyzed information. The risk is an index for expressing the possibility of a malicious code being inserted in the process of maliciously repackaging an Android application, i.e., a target to be analyzed.

The analysis system 100 determines whether or not an application is repackaged and blocks execution of the repackaged application depending on the level of the risk converted into a score.

The risk calculation module 110 expresses a risk of an application as a score based on the analysis information transferred to the analysis module 106, and the risk calculation module 110 calculates a total score by reflecting the analysis information of the name analyzer 106a as 50% points of the total score, the analysis information of the ID analyzer 106b as 20% points, and the analysis information of the string analyzer 106c as 30% points.

For example, if it is assumed that the total score is 100 points, a score obtained by analyzing whether or not the names are identical is 20 points, a score obtained by analyzing the risk of a publisher ID is 20 points, and a score obtained by analyzing the risk of a malicious code is 30 points.

A method of analyzing a repackaged application using such a configuration is described with reference to FIG. 3.

First, the analysis system 100 loads a specific application, i.e., a target to be analyzed 5102. The specific application may be an application stored in the application database 104 or an application installed in an Android mobile terminal of a user.

The decompiler 102 decompiles the AndroidManifest file and the Dex file and transfers the decompiled AndroidManifest file and Dex file to the analysis module 106 S104.

The name analyzer 106a determines a degree of similarity between the package name and the main activity name by analyzing the AndroidManifest file and transfers the analyzed information to the risk calculation module 110 to converts the risk into a score 5106.

If the main activity name is a combination of the package name and the last portion of the package name as shown in FIG. 4 as a result of the analysis of the risk calculation module 110, the application is regarded as a normal application, and the risk score is calculated as 5 points.

Then, if the main activity name is completely different from the package name as shown in FIG. 5, the application is regarded as a repackaged application, and the risk calculation module 110 calculates the risk score as 50 points.

Then, when the main activity name is formed by appending a character string that is originally not in the package name to the package name while the package name is contained the main activity name as is as shown in FIG. 6, the application is regarded as a repackaging suspected application, and the risk calculation module 110 calculates the risk score as 15 points.

Meanwhile, the ID analyzer 106b determines whether or not a published ID is found in the white list or the blacklist by analyzing the AndroidManifest file and transfers the analyzed information to the risk calculation module 110 to converts the risk into a score 5108.

The risk score is calculated as 0 point if the published ID is contained in the white list, 20 points if contained in the blacklist, and 10 points if not contained in both the white list and the blacklist.

The string analyzer 106c determines whether or not a malicious package name or a malicious code character string is found in the AndroidManifest file or the Dex file by analyzing the AndroidManifest file and the Dex file and transfers the analyzed information to the risk calculation module 110 to converts the risk into a score 5110.

The risk score is calculated as 0 point if the malicious package name or the malicious code character string is not found at all, 12 points if only the malicious package name is found, and 30 points if the malicious code character string is found. When e malicious code character string is found, the score is calculated as 30 points, i.e., the highest score, regardless whether or not the malicious package name is found.

The risk calculation module 110 finally converts the risk of the analysis target application into a score using the application analysis information and detects a repackaged application containing a malicious code based on the result of the conversion S112.

The risk score of a corresponding application is 5 points out of 100 points if the package name is identical to the main activity name and the last portion of the package name is appended to the main activity name (5 points), the publisher ID is in the white list (0 point), and the malicious package name or the malicious code character string is not found at all (0 point).

The total score is 100 points out of 100 points if the package name is completely different from the main activity name (50 points), the publisher ID is in the blacklist (20 point), and the malicious code character string is found (30 point), and the application is considered as being a 100% repackaged malicious application.

Although the scores for defining an application as a normal, suspected or malicious application will be determined according to the characteristic, type, distribution channel or the like of the application, the scores may be roughly set into sections.

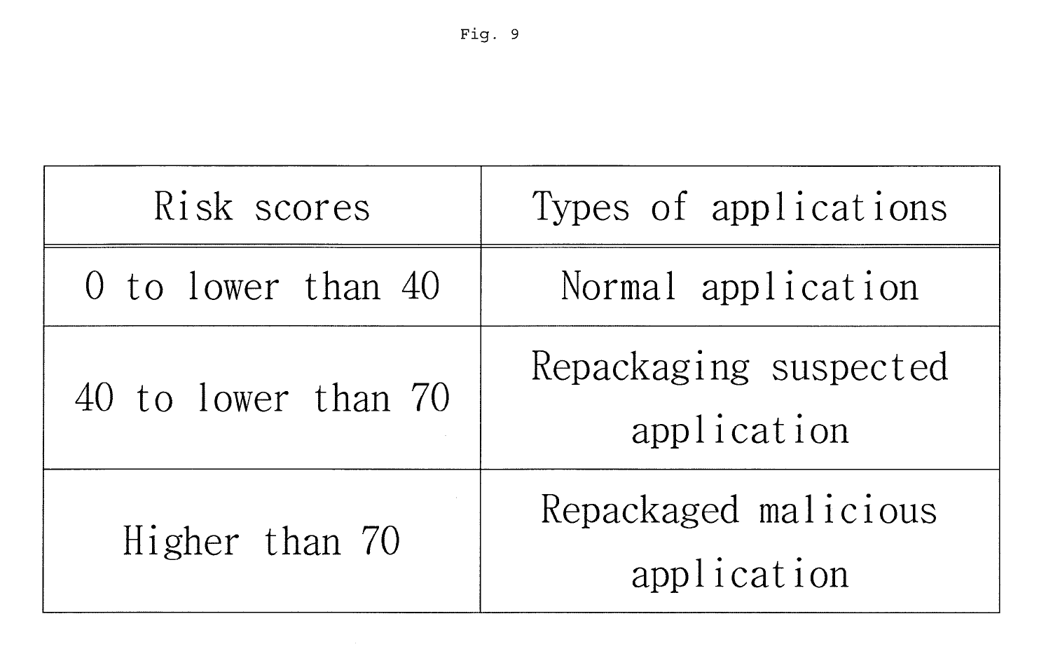

FIG. 9 is a table showing the types of applications corresponding to risk points.

As shown in FIG. 9, if the risk is scored out of 100 points in the present invention, an application is determined as a normal application if the risk score is 0 point or higher and lower than 40 points, a repackaging suspected application if the risk score is 40 points or higher and lower than 70 points, and a repackaged malicious application if the risk score is 70 points or higher.

When a repackaged application is found, the analysis system 100 informs a user of finding the corresponding application and blocks execution of the repackaged application 5114.

Although an application blocked by the analysis system 100 not to be executed is generally a ‘repackaged malicious application’, execution of a ‘repackaging suspected application’ may also be blocked according to a security level set by a user.

According to the present invention, malicious applications classified as a repackaged mutant may be extensively detected.

Furthermore, according to the present invention, malicious application detection errors may be minimized since a risk calculation method for scoring a risk is applied, and unknown threatening applications may be detected and blocked in advance through reputation-based detection.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for analyzing a repackaged application through risk calculation, which detects the repackaged application by analyzing an Android application, the system comprising:
a decompiler 102 for loading the Android application, which is an analysis target, decompressing the application and extracting an AndroidManifest file and a Dex file;
an analysis module 106 for analyzing whether or not specific information is modified in the extracted AndroidManifest or Dex file;
a blacklist database 108 for storing a blacklist collecting IDs of publishers related to creation and distribution of a malicious code, a white list collecting IDs of publishers unrelated to creation and distribution of the malicious code, and information on malicious package names and malicious code character strings; and
a risk calculation module 110 for converting, if analysis information on the Android application created by the analysis module 106 is transmitted, a risk expressing possibility of the malicious code to be contained in the Android application as a score based on the analysis information; wherein
the Android application, which is the analysis target, is classified as one of a normal application, a repackaging suspected application and a repackaged malicious application depending on the risk.

2. The system according to claim 1, wherein the analysis module 106 includes:
a name analyzer 106a for extracting a package name and a main activity name from application information contained in the AndroidManifest file, analyzing a degree of similarity between the package name and the main activity name, and transferring the degree of similarity to the risk calculation module 110;
an ID analyzer 106b for analyzing whether or not a publisher ID contained in the AndroidManifest file is found in the white list or the blacklist, and transferring a result of the analysis to the risk calculation module 110; and
a string analyzer 106c for analyzing whether or not a malicious package name or a malicious code character string is found in the AndroidManifest file or the Dex file, and transferring a result of the analysis to the risk calculation module 110.

3. A method of analyzing a repackaged application through risk calculation, which detects the repackaged application using the analysis system of claim 1, the method comprising:
a first step of loading an Android application, which is an analysis target, decompressing the application and extracting an AndroidManifest file and a Dex file, by a decompiler 102;
a second step of analyzing whether or not specific information is modified in the extracted AndroidManifest or Dex file, by an analysis module 106;
a third step of converting, if analysis information on the Android application created by the analysis module 106 is transmitted, a risk expressing possibility of the malicious code to be contained in the Android application as a score based on the analysis information, by a risk calculation module 110; and
a fourth step of classifying the Android application as one of a normal application, a repackaging suspected application and a repackaged malicious application depending on the risk, by the risk calculation module 110.

4. The method according to claim 3, wherein the second step includes:
a 2-1 step of extracting a package name and a main activity name from application information contained in the AndroidManifest file, analyzing a degree of similarity between the package name and the main activity name, and transferring the degree of similarity to the risk calculation module 110, by a name analyzer 106a included in the analysis module 106;
a 2-2 step of analyzing whether a publisher ID contained in the AndroidManifest file is found in a white list or a blacklist, and transferring a result of the analysis to the risk calculation module 110, by an ID analyzer 106b included in the analysis module 106; and
a 2-3 step of analyzing whether or not a malicious package name or a malicious code character string is found in the AndroidManifest file or the Dex file, and transferring a result of the analysis to the risk calculation module 110, by a string analyzer 106c included in the analysis module 106.

5. The method according to claim 4, wherein as a result of the analysis of the name analyzer 106a at the 2-1 step,
if the main activity name is configured in a form of combining the ‘package name’ and a ‘last portion of the package name’ using ‘.’, the risk calculation module 110 adds 5% points to the risk score of the Android application,
if the main activity name is different from the package name and does not contain the package name, the risk calculation module 110 adds 50% points to the risk score of the Android application, and
if the main activity name is different from the package name and contains the package name, the risk calculation module 110 adds 15% points to the risk score of the Android application, and

6. The method according to claim 4, wherein as a result of the analysis of the ID analyzer 106b at the 2-2 step,
if the publisher ID is contained in the white list, the risk calculation module 110 adds no point to the risk score of the Android application,
if the publisher ID is contained in the blacklist, the risk calculation module 110 adds 20% points to the risk score of the Android application, and
if the publisher ID is not contained in both the white list and the blacklist, the risk calculation module 110 adds 10% points to the risk score of the Android application.

7. The method according to claim 4, wherein as a result of the analysis of the string analyzer 106c at the 2-3 step,
if the malicious package name and the malicious code character string are not found, the risk calculation module 110 adds no point to the risk score of the Android application,
if the malicious package name is found, the risk calculation module 110 adds 12% points to the risk score of the Android application, and
if the malicious code character string is found, the risk calculation module 110 adds 30% points to the risk score of the Android application.

8. A method of analyzing a repackaged application through risk calculation, which detects the repackaged application using the analysis system of claim 2, the method comprising:
a first step of loading an Android application, which is an analysis target, decompressing the application and extracting an AndroidManifest file and a Dex file, by a decompiler 102;
a second step of analyzing whether or not specific information is modified in the extracted AndroidManifest or Dex file, by an analysis module 106;
a third step of converting, if analysis information on the Android application created by the analysis module 106 is transmitted, a risk expressing possibility of the malicious code to be contained in the Android application as a score based on the analysis information, by a risk calculation module 110; and
a fourth step of classifying the Android application as one of a normal application, a repackaging suspected application and a repackaged malicious application depending on the risk, by the risk calculation module 110.
